(19) United States
(12) Patent Application Publication
(10) Pub. No.: US 2011/0178868 A1
(43) Pub. Date: Jul. 21, 2011

(54) ENHANCING SEARCH RESULT PAGES USING CONTENT LICENSED FROM CONTENT PROVIDERS

(76) Inventors: Priyank Shanker Garg, Santa Clara, CA (US); Tuoc Vinh Luong, San Jose, CA (US); Hari Vasudev, Milpitas, CA (US)

(21) Appl. No.: 12/691,640

(22) Filed: Jan. 21, 2010

(51) Int. Cl. G06Q 30/00; G06F 17/30

(52) U.S. Cl. 705/14.45; 707/709; 705/14.69; 707/E17.108; 705/14.49

(57) ABSTRACT

A search engine provider enters into an agreement with a content provider wherein the search engine provider agrees to provide compensation in exchange for the content provider giving content to the search engine provider. The content may comprise data that normally can't be accessed without a subscription, or any other content. The content may comprise information that indicates a structure of the content provider's web pages. The search engine may display normally inaccessible content with search results. The search engine may use structural information to classify and extract data items from web pages, and to highlight those data items in search results with labels that identify each such data item's class. A computing device determines the extent to which enhancement of the search results page using the content provider's content increased the revenue value of the page. The amount paid to the content provider may be based on this extent.

### FIELD OF THE INVENTION

The present invention relates to Internet search engines and, more specifically, to a technique whereby a search engine provider compensates a content provider in exchange for the content provider allowing the search engine provider to place, on a search results page, content from the content provider that otherwise normally would not be accessible on the search results page.

### BACKGROUND

The Internet is a vast collection of interlinked information resources. These resources prominently include web pages, which are documents that are typically (but not always) formatted according to some markup language such as Hypertext Markup Language (HTML) or Extensible Markup Language (XML). These web pages may contain human-readable text as well as other kinds of media, such as still images, motion video, audio, and executable computer programs. Often, these web pages will include hypertext links to other web pages. Each such web page is typically hosted on some Internet-accessible web server. Each such web server is typically associated with a unique Uniform Resource Locator (URL), and each web page that is hosted on that web server is typically associated with a unique URL that is a qualified, extended version of the web server's URL. By entering a web page's URL into a navigation field of a web browsing application (e.g., Mozilla Firefox) executing on his computing device, a user can cause his web browsing application to request the contents of that web page over the Internet from the web server on which that web page is hosted. Such a request is normally made using a multi-layered suite of communication protocols such as Internet Protocol (IP), Transmission Control Protocol (TCP), and Hypertext Transmission Protocol (HTTP). In response to receiving such a request, a web server that hosts the requested page usually will return that web page's contents, over the Internet, to the user's web browsing application. Upon receiving the web page's contents, the web browsing application renders the web page for display to the user, who may then interact with certain elements contained within the web page. This assumes that the user is capable of providing authentication credentials to the web server if the web server requires such credentials; if a web server requires such credentials, and if the user is unable to supply such credentials to the web server, then the web server may deny the user's request for the web page.

Because the quantity of resources on the Internet is so vast, and because it would be amazingly difficult for any user to determine, unassisted, the URLs of all, or even most, resources that pertain to a particular concept in which the user is interested (especially considering the ever-changing, dynamic nature of the Internet), users often turn to Internet search engines to assist them in locating such resources on the Internet. A search engine is an automated process that executes on a search engine provider's web server. The search engine provided by Yahoo! Inc. is one such search engine. By directing his web browsing application to the search engine's URL, a user causes his web browsing application to request, from the search engine, a “front page” that usually contains a query term field into which the user can enter one or more query terms that indicate concepts about which the user is interested in finding more information on the Internet. A user may submit query terms to the search engine over the Internet by typing the query terms into the query term field (or by selecting recommended query terms from a list of recommended query terms that the search engine itself provides to the user) and activating a “submit” button or other control on the “front page.” Increasingly, users also submit query terms to a search engine by entering those query terms into a “tool bar” that executes on the user's computing device in conjunction with the user's web browsing application.

When a search engine receives query terms over the Internet from a user, the search engine consults an index to determine a set of web pages that are relevant to the query terms. Typically, these will be web pages that contain one or more of the query terms. The search engine then dynamically constructs a search results web page that contains references to (e.g., hyperlinks to) the query term-relevant web pages, and returns the search results web page to the user's computing device over the Internet. After the user's web browsing application has received the search results web page and rendered the search results web page for the user, the user then can easily cause his web browsing application to navigate to any of the relevant web pages by “clicking on” (with his mouse or pointing device) or otherwise selecting the references to those web pages.

Commonly now, a “front page” initially provided by a search engine, and/or the search results web pages that the search engine returns in response to user queries, also contain advertisements. These are usually advertisements that the search engine provider has incorporated into the “front page” or search results web pages in exchange for some monetary compensation from the advertisers that provided those advertisements to the search engine provider. The advertisements are often dynamically and automatically selected for placement on a search results web page so that the advertisements placed relate to products and services that are related to (a) the query terms that the user submitted and/or (b) the search results that are contained within the search results page. Under some systems of advertisement, advertisers “bid” on keywords that may be submitted as query terms, and the highest bidder's advertisement is subsequently placed on a search results page that was generated in response to a user's submission of that keyword as a query term. A search engine provider generally desires to make the content on its “front page” as enticing as possible, and the results contained within the search results web pages as relevant to the query terms as possible, in order to encourage a larger base of users to use its search engine, so that more advertisers will be willing to pay more money to the search engine provider in exchange for the privilege of having their advertisements displayed on the search engine's page. Revenues from advertisers may be the most significant source of revenue for the search engine provider. In order to provide the most relevant results possible to searching users, the search engine provider seeks to discover and locate as many Internet-accessible resources as it can.

The set of relevant web pages that is returned to the user in the search results web page is limited to web pages that are contained in a “search corpus” of web pages that the search engine's provider has already discovered on the Internet. Usually, this search corpus is populated by an automated “web crawler” of the search engine provider. The web crawler is an automated process that often executes on the search engine provider's servers. The web crawler follows hypertext links contained in a web page to other web pages to which those hypertext links refer. Thus, the web crawler “crawls” from web page to web page in a systematic, methodical manner which is directed by a specified algorithm. At each web page that the web crawler “visits” in this manner, the web crawler determines stores a copy of that web page into the search corpus (which may be in the form of a database maintained on the search engine provider's servers) and places, into an index, entries that point to that web page (usually to that web page's unique URL). Each such entry for the web page may include a word, term, or phrase that is contained in the web page. Thus, as a result of the indexing process, the index may contain, for each word in the web page, a separate index entry that associates that word with the web page's unique URL. Later, in determining whether a particular web page is relevant to a set of user-submitted query terms, the search engine may search the index for all of the web pages are associated with at least some of the query terms, using those query terms as the search keys. The index may be implemented in a variety of ways that allow for rapid searching, such as a B-tree.

There is a segment of the Internet that automated web crawlers have great difficulty crawling. This segment is sometimes referred to as the “hidden web.” The hidden web includes, for example, some dynamically generated web pages that do not actually exist until information is submitted to a web server that generates that web page. The hidden web also includes some web pages, which may be either static or dynamically generated, which are inaccessible to users and web crawlers who are unable to provide, to the web servers hosting those web pages, authentication credentials that those web servers demand. Sometimes, a user can only obtain such authentication credentials from a web server by first establishing an account with the web server (or, in other words, the web site that is hosted by the web server). The establishment of such an account may involve a subscription, which might or might not require the subscribing user to agree to pay some monetary amount (sometimes on a recurring basis) to the web site's provider. Web pages that are only accessible to subscribers—especially web pages that are only available to those subscribers who agree to pay—usually are not included within the set of web pages that a web crawler automatically crawls. Because these web pages are usually not placed into a search engine's search corpus, the search results that a search engine returns to a user usually will not contain any reference to these web pages. This will be the case even if the content contained on those “privileged user” web pages happens to be the most relevant information on the Internet to the query terms that a user submits to the search engine.

A slightly different topic related to search engines concerns the type of information that the search engine displays with each search result on a search results web page. Traditionally, each search result has included a title of the corresponding web page, a URL and hyperlink to that web page, and an abstract for that web page. More sophisticated search engines more recently also have included more detailed, categorized information that web crawlers have been able to detect and extract from web pages. For example, if a web page includes a business' name, address, and telephone number, then, using a pattern-recognition algorithm, a web crawler might be able to detect that name, address, and telephone number, and individually extract those items of information from the web page, categorizing each such item as being what it is—a name, address, or telephone number, for example. Consequently, when the search engine generates a search result for the web page on a search results page, the search engine may “surface” or “highlight” each such categorized item of information in that search result, thereby identifying to the user what that information item is, and sparing the user from having to search the web page itself for that information item (which is calculated to be an item from an information category—such as name, address, or telephone number—in which users are typically interested). The inclusion of such category-labeled details in a search results web page makes the searching user's experience with the search engine more satisfying, encouraging that user and other users to use the search engine.

Some information items in a web page are not easily detected automatically using a general pattern-recognition algorithm, though. Because different web sites often structure their web pages according to different organizational structures, a search engine provider may have great difficulty in formulating a general pattern-recognition algorithm that is capable of extracting all categories of information from all web pages of all web sites. Indeed, the organizational structure of some web sites might be so non-conducive to automated extraction that certain information items on those site's web pages, which actually do belong to distinct categories that could otherwise be “surfaced” or “highlighted” in search results, simply cannot be automatically discovered and extracted by a web crawler that only has a general pattern recognition algorithm, not especially applicable to any specific web site, at its disposal. For example, although a web site's pages might each include a different product name and price, which information items might be of particular interest to a user of a search engine, and which information items would be beneficially displayed in search results for such pages, a web crawler might have no means of determining that a particular segment of information on such a page actually represents a product name or a price.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates an example of a technique by which a search results page containing references to “privileged” user content is returned to a search engine user, according to an embodiment of the invention;

FIG. 2 is a flow diagram that illustrates an example of a technique by which a search results page containing categorized, detailed information items extracted from a content provider's web pages using structural information obtained from that content provider is returned to a search engine user, according to an embodiment of the invention;

FIG. 3 is a block diagram that illustrates an example of a search results web page that contains a search result listing that includes detailed information items that were automatically extracted from the web page corresponding to the search results listing using structure-indicating information that the content provider (who hosts the web page) provided to the search engine provider, according to an embodiment of the invention;

FIG. 4 is a block diagram of a computer system on which embodiments of the invention may be implemented; and

FIG. 5 is a block diagram of a multi-computing device, Internet-based system in which embodiments of the invention may be used.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

A search engine provider enters into an agreement with a content provider wherein the search engine provider agrees to provide compensation (e.g., monetary compensation) in exchange for the content provider granting, to the search engine provider, content to which the search engine provider normally would not have access in the absence of the agreement. The content may comprise data to which access is normally not available to a user unless that user has subscribed to a service provided by the content provider, for example. Additionally or alternatively, the content may comprise information that discloses in detail the structure by which the content provider's content is organized on pages that contain that content. The search engine provider benefits by obtaining either kind of content from the content provider. When the content is data to which access is normally not available to the non-subscribing user, the search engine may display that content to the search engine's users in conjunction with search results. When the content is structural information, the search engine may use that structural information to classify data items of particular interest on the content provider's pages automatically, to extract those data items from those pages automatically, and to make prominent those data items in search results with labels that precisely identify the class of each such data item. Either kind of content that the search engine provider obtains from the content provider enhances the experience of the search engine's users, thereby drawing more users to use the search engine. Thus, the search engine provider benefits from increased user interest, while the content provider benefits from the compensation that the search engine provider agrees to give in exchange for the content provider's content.

Although examples are provided herein of a content provider making available to the search engine provider, by agreement with the search engine provider, content for which a user would normally need to subscribe or pay in order to gain access, at least some embodiments of the invention may involve the content provider making available content that does not ordinarily require such payment or subscription. Examples described below include examples in which a search engine provider pays a content provider based on the content provider making available, to the search engine provider, content that is usually limited in access, or content that indicates a structure of pages on a content provider's website. However, at least some embodiments of the invention may involve the search engine provider agreeing to pay the content provider in exchange for the content provider providing or making available, to the search engine provider, even content that is not limited in access at all, and that does not indicate any structural information concerning the content provider's web pages. The types of information that a content provider may agree to make available to the search engine provider, in various embodiments of the invention, are virtually without limit.

### Search Results Containing “Privileged User” Content

As is discussed above, in one embodiment of the invention, in exchange for compensation from the search engine provider, a content provider makes available, to the search engine provider, information from the content provider's web site(s) that ordinarily would be available only to a “privileged” user who had (a) subscribed to the web site(s) or (b) paid the content provider for the privilege of viewing the information on the web site(s). As a consequence of the agreement between the search engine provider and the content provider, the search results web page that the search engine returns to the user contain results that point to web pages that usually would only be available to such a “privileged” user—even though the user viewing the search results page might not have actually subscribed to the content provider's web site(s) or paid for the privilege of viewing information contained within the pages thereof.

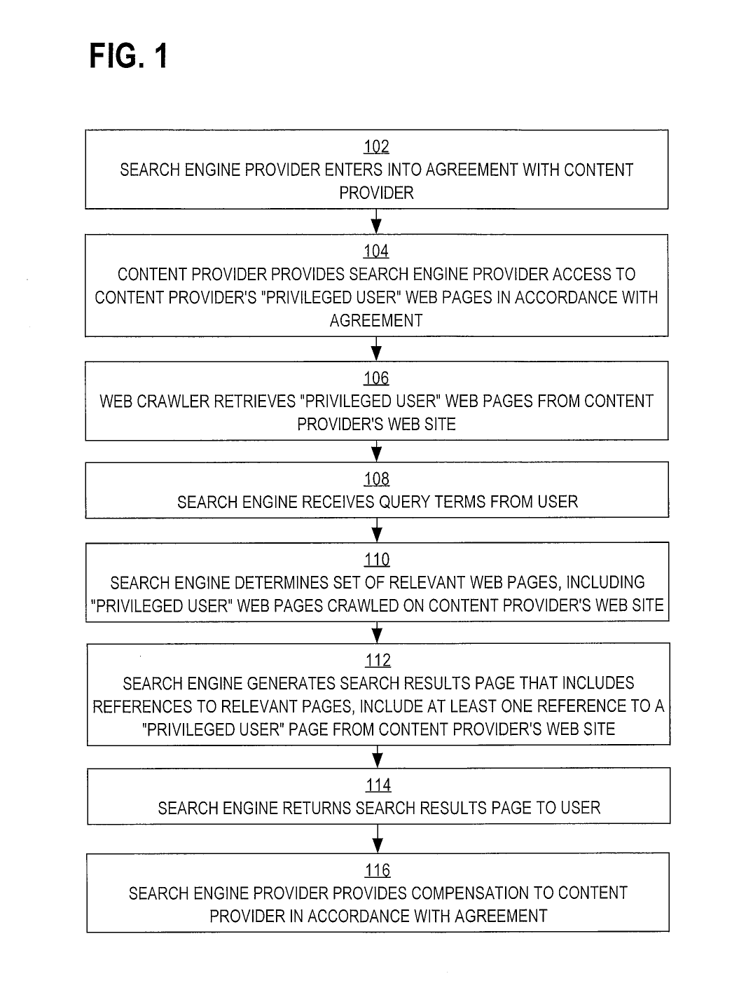

FIG. 1 is a flow diagram that illustrates an example of a technique by which a search results page containing references to “privileged” user content is returned to a search engine user, according to an embodiment of the invention. In block 102, a search engine provider enters into a legally binding agreement with a content provider. In the agreement, the search engine provider agrees to provide compensation, such as monetary compensation, to the content provider in exchange for the content provider allowing the search engine provider to access privileged user information on the content provider's web site(s). The content provider may be a provider of an on-line magazine or newspaper, for example. The privileged information may be content that is contained on the web pages of such an on-line magazine or newspaper, for example.

In block 104, in response to the entrance of the search engine provider and the content provider into the agreement, the content provider provides the search engine provider access to the privileged user information on the content provider's web site(s). For example, the content provider may create, on the content provider's web server, a privileged user account specifically for the search engine provider—such as the kind of the account that would be created for a user who had subscribed to the content provider's web site(s) or a user who had paid the content provider for the privilege of accessing the information contained on the pages of the content provider's web site(s). The privileged user account may be associated with a user name and password that the content provider provides to the search engine provider in response to the entrance of the search engine provider into the agreement.

In block 106, the search engine provider's automated web crawler (which is a process that executes on a computing device) retrieves, from the content provider's web site(s), information that is contained on the web pages that are accessible only to “privileged” users. For example, when the automated web crawler is challenged by the content provider's web server for a username and password at the time that the automated web crawler attempts to access (or “crawl”) such a web page, the automated web crawler may return, to the content provider's web server, the username and password that are associated with the user account that the content provider created for the search engine provider in response to the search engine provider's entrance into the agreement. As a result, the automated web crawler obtains access to web pages that the web crawler would not have been able to access in the absence of the agreement. The automated web crawler then indexes the content contained on these privileged user web pages in the manner that the web crawler ordinarily indexes content contained on web pages that the web crawler “crawls.” For example, for each such web page, the web crawler may store the contents of that web page into a database that the search engine provider maintains. For each word (or each non-trivial word) in that web page, the web crawler may insert, into an index that the search engine provider maintains, an association between that word and the web page's unique identifier (which may constitute a universal resource locator (URL) at which the web page was found). Other non-textual kinds of media, such as images and motion video content, that are contained on that web page also may be stored in the database and indexed. The web crawler may perform such content retrieval and indexing periodically, on multiple occasions, so that if the content of a “privileged user” web page changes, the database and index will rapidly reflect the updates to that web page.

In block 108, the search engine provider's search engine receives, from a user of that search engine, one or more query terms. The query terms typically indicate concepts about which the user is interested in finding information on the Internet. For example, the search engine may receive the query terms from the user as the result of the user entering those query terms into a “query term field” that is displayed on (a) a “front page” of the search engine provider's web site or (b) a “tool bar” that executes on the user's computing device in conjunction with the user's web browsing application (e.g., Mozilla Firefox). For another example, the search engine provider may receive the query terms from the user as a result of the user selecting those query terms from a list of recommended query terms that the search engine provides to the user either on the “front page” or by the “tool bar” discussed above. In one embodiment of the invention, the search engine receives the query terms over the Internet from the user's computing device.

In block 110, in response to receiving the query terms from the user, the search engine automatically determines a set of web pages that are relevant to the query terms. For example, using the index discussed above, the search engine may select, from the corpus of previously “crawled” web pages that are stored in the search engine provider's database, a set of “relevant” web pages that each contain one or more of the query terms received from the user. In one embodiment of the invention, the search engine ranks these web pages relative to each other based at least in part on the web pages' relevance to the query terms. The ranking may be based on multiple factors, including, for example, the number of occurrences of each query term within a particular web page, and/or the quantity of hypertext links to the particular web page from other web pages, and/or the quantity of hypertext links from the particular web page to other web pages. Significantly, because the web crawler has previously retrieved and indexed web pages that the web crawler accessed after providing requested authentication to the content provider's web server, as discussed above, the set of web pages that the search engine determines to be relevant to the query terms may include “user privileged” web pages to which references ordinarily would not be returned by a search engine within a search results web page.

In block 112, the search engine automatically generates a search results web page that contains references to at least some of the web pages in the set that the search engine determined to be relevant to the query terms. For example, the search results web page may contain references to the “N” most relevant web pages in the set, where “N” is some specified quantity. Each reference may include a title of the corresponding web page, a hyperlink to the corresponding web page (which may indicate the URL of the corresponding web page), and an abstract of the corresponding web page. The abstract may be a static abstract that the web crawler extracted, unchanged, from the corresponding web page, or a dynamic abstract that the search engine dynamically generated from the web page's contents based at least in part on the query terms. In the latter case, the abstract may include “snippets” of the corresponding web page that contain instances of the query terms and the text surrounding those instances. Significantly, the references contained on the search results web page may include references to “privileged user” web pages. Not only may the search results page contain references to such “privileged user” web pages, but the search results page also may contain (e.g., in the abstracts for one or more search results) actual content that was extracted from those “privileged user” web pages. Consequently, the search results page itself may contain content that a user would not ordinarily be able to access if that user had not subscribed to the content provider's web site(s) or otherwise paid the content provider for the privilege of accessing that content. A user who might not ever have subscribed to the content provider's web site(s) or paid for the privilege of accessing the content provider's web site(s) therefore, nevertheless, may be able to view at least some of that privileged user content on the search results web page itself (e.g., in the abstracts of the search results), even without directing his web browsing application to any of the web pages that are references by the hyperlinks contained on the search results web page. In essence, the search engine provider has “paid the way” for the search engine user to be able to view the privileged user content.

In block 114, the search engine returns the generated search results web page to the user as a response to the user's previous submission of the query terms. In one embodiment of the invention, the search engine returns the search results page to the user's computing device over the Internet. Typically, the user's web browsing application receives the search results page and displays the search results page to the user. Because the search results page may contain “privileged user” content that the user would not be able to obtain from other search engines (because the providers of those other search engines had not entered into an agreement of the kind discussed above with the content provider), the user is likely to want to use the current search engine again and again. The user is likely to want to recommend the current search engine, over other search engines, to his friends and acquaintances. As a result, the search engine provider's user base increases. The traffic to the search engine provider's “front page” increases. This allows the search engine provider to increase advertising revenues from prospective advertisers, as advertisers seek to have their advertisements placed on the search engine provider's “front page,” or on the search results pages that the search engine generates, due to the large quantity of users who visit and view that “front page” and/or receive those search results pages. Although a single content provider is discussed above for sake of simplicity of illustration, in some embodiments of the invention, the search engine provider will enter into multiple agreements with multiple different content providers, so that search results pages that the search engine generates may include “privileged user” content from multiple different content providers.

In block 116, the search engine provider provides compensation to the content provider in accordance with the agreement into which both previously entered. In one embodiment of the invention, the compensation is monetary compensation, and is provided to the content provider in an automated manner. For example, the agreement might indicate that, each time that content from any of the content provider's “privileged user” web pages is presented to a user on a search results web page, the search engine provider will pay the content provider some specified monetary amount. For another example, the agreement might indicate that each time that a user “clicks on” or otherwise selects or activates a hyperlink or other reference to any of the content provider's “privileged user” web pages from the search results web page, the search engine provider will pay the content provider some specified monetary amount. Alternatively, the agreement might indicate that the search engine provider will pay a specified amount as a single lump sum or periodically regardless of whether the content provider's content is ever displayed in a search results page and/or regardless of whether a user ever “clicks on” a hyperlink to the content provider's content from a search results page. An automated process executing on the search engine provider's computing device may maintain a tally of the amount that the search engine provider currently owes to the content provider. The automated process may periodically, or in response to some specified increase in that tally, credit a specified bank or other financial account with monetary amounts owed to the content provider.

Content providers are motivated to make their “privileged user” content available to the search engine's users due to the compensation that the search engine provider agrees to give those content providers in exchange. Thus, content providers' possible concerns over the loss of revenue that might result by making available (on the search engine provider's search results pages), to non-paying or non-subscribing users, content for which user would normally need to pay the content provider, and/or content to which such users normally would need to subscribe (e.g., by establishing an account with the content provider's web site), are assuaged.

### Extracting Details Using Content Provider's Page Structure

As is discussed above, in one embodiment of the invention, in exchange for compensation from the search engine provider, a content provider makes available, to the search engine provider, data that indicates the structure of the web pages on the content provider's web site. Using this data, the search engine provider's web crawler can automatically extract and categorize detailed information items, such as business names, addresses, phone number, product names, prices, reviews, etc., from the web pages of the content provider's web site. Without obtaining such structure-indicating data from the content provider itself, the search engine provider's web crawler would only be able to extract web page information based on a generalized pattern-recognition algorithm that is applicable to all web pages, but lacks precision due to its generally applicable nature. Therefore, the receipt of the structure-indicating data from the content provider itself (who knows intimately the structure to which its own web pages conform) enables the search engine provider's web crawler to extract and classify detailed information items from the content provider's web pages automatically. The search engine provider's search engine then can provide these detailed information items within the search results that are contained on the search results page that the search engine generates for users. In the search results web page, the search engine can label each of these detailed information items to indicate the class or category (e.g., name, address, phone number, product name, price, review, etc.) to which each such detailed information item belongs.

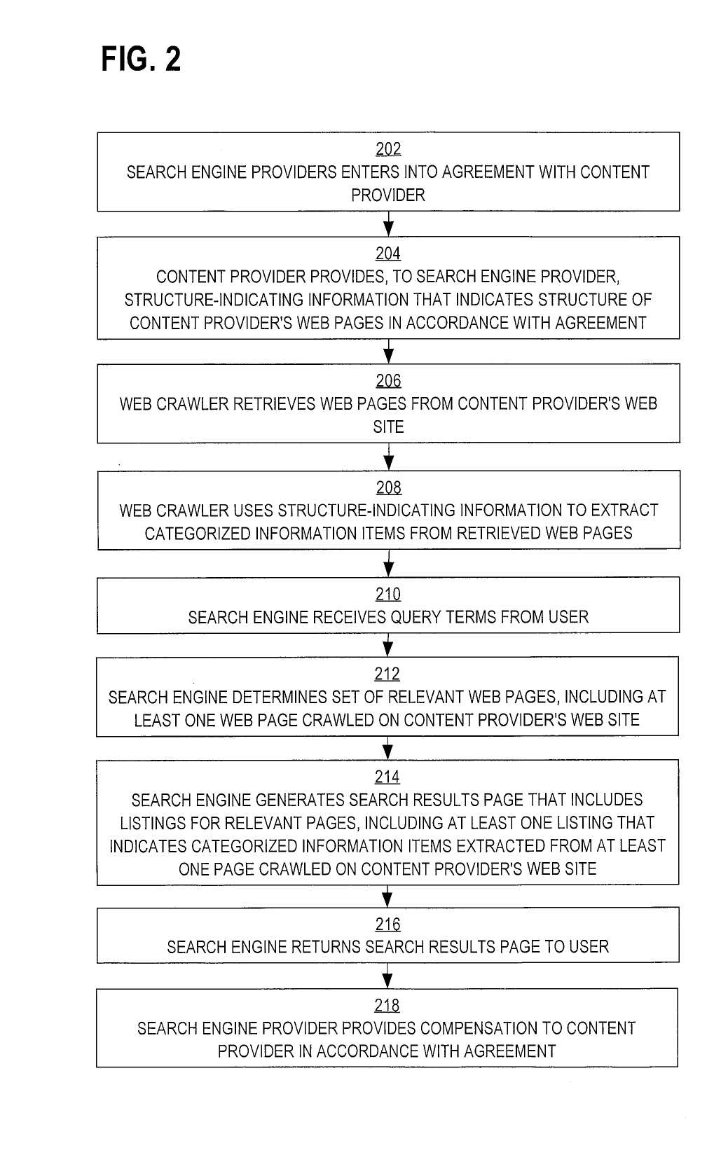

FIG. 2 is a flow diagram that illustrates an example of a technique by which a search results page containing categorized, detailed information items extracted from a content provider's web pages using structural information obtained from that content provider is returned to a search engine user, according to an embodiment of the invention. In block 202, a search engine provider enters into a legally binding agreement with a content provider. In the agreement, the search engine provider agrees to provide compensation, such as monetary compensation, to the content provider in exchange for the content provider giving the search engine provider information that indicates a structure of one or more web pages of the content provider's web site(s). The content provider may be a provider of an on-line store or business, for example.

In block 204, in response to the entrance of the search engine provider and the content provider into the agreement, the content provider gives the search engine provider the information that indicates the structure of one or more web pages of the content provider's web site(s). For example, the content provider may provide, to the search engine provider, an XML schema that indicates a structure to which all of the XML pages of the content provider's web site(s) conform. The XML schema indicates a separate path (e.g., an XPath) to each distinct information item on the web pages of the content provider's web site(s). For another example, the content provider may provide, to the search engine, one or more regular expressions, each of which corresponds to a specific category of information (e.g., name, address, phone number, product name, price, review, etc.) that may be found on the web pages of the content provider's web site(s). Pattern-matching against a web page of the content provider using the regular expression yields an information item on that web page that is of the category with which the regular expression is associated. Other techniques for indicating a structure of a web page and a position at which specific categories of information are found within each of the web pages of the content provider's web site(s) also may be used; the foregoing examples should not be interpreted as being an exhaustive list of such techniques.

In block 206, the search engine provider's automated web crawler (which is a process that executes on a computing device) automatically retrieves web pages from the content provider's web site(s). For example, the web crawler may follow links between the web pages of the content provider's web site(s) in order to crawl and index all of the web pages of those web site(s), using traditional web-crawling techniques.

In block 208, for each web page that the search engine provider's web crawler retrieved in block 206, the web crawler (or some other process) applies, to that web page, the structure-indicating information received from the content provider in block 204. The web crawler's application of the structure-indicating information to such a web page enables the web crawler to identify and locate, on that web page, information items that belong to specific categories (e.g., name, address, phone number, product name, price, review, etc.). For example, the web crawler may apply the structure-indicating information by finding information items in the content provider's web page(s) that match a pattern indicated by a regular expression (given by the content provider) that is associated with a particular category of information item. For another example, the web crawler may apply the structure-indicating information by finding information items in the content provider's web page(s) that occur at specific XPaths within an XML schema (given by the content provider), where each such XPath is associated with a separate category of information item. After finding, in the content provider's web page(s), information items that belong to specific categories, the web crawler extracts those information items from the content provider's web page(s), and stores each such extracted information item in association with both (a) an identity of the web page from which that information item was extracted and (b) an identity of the category to which that extracted information item corresponds, as indicated by the structure-indicating information that the search engine provider previously received from the content provider.

In block 210, the search engine provider's search engine receives, from a user of that search engine, one or more query terms. The query terms typically indicate concepts about which the user is interested in finding information on the Internet. For example, the search engine may receive the query terms from the user as the result of the user entering those query terms into a “query term field” that is displayed on (a) a “front page” of the search engine provider's web site or (b) a “tool bar” that executes on the user's computing device in conjunction with the user's web browsing application (e.g., Mozilla Firefox). For another example, the search engine provider may receive the query terms from the user as a result of the user selecting those query terms from a list of recommended query terms that the search engine provides to the user either on the “front page” or by the “tool bar” discussed above. In one embodiment of the invention, the search engine receives the query terms over the Internet from the user's computing device.

In block 212, in response to receiving the query terms from the user, the search engine automatically determines a set of web pages that are relevant to the query terms. For example, using the index discussed above, the search engine may select, from the corpus of previously “crawled” web pages that are stored in the search engine provider's database, a set of “relevant” web pages that each contain one or more of the query terms received from the user. In one embodiment of the invention, the search engine ranks these web pages relative to each other based at least in part on the web pages' relevance to the query terms. The ranking may be based on multiple factors, including, for example, the number of occurrences of each query term within a particular web page, and/or the quantity of hypertext links to the particular web page from other web pages, and/or the quantity of hypertext links from the particular web page to other web pages.

In block 214, the search engine automatically generates a search results web page that contains references to at least some of the web pages in the set that the search engine determined to be relevant to the query terms. For example, the search results web page may contain references to the “N” most relevant web pages in the set, where “N” is some specified quantity. Each reference may include a title of the corresponding web page, a hyperlink to the corresponding web page (which may indicate the URL of the corresponding web page), and an abstract of the corresponding web page. The abstract may be a static abstract that the web crawler extracted, unchanged, from the corresponding web page, or a dynamic abstract that the search engine dynamically generated from the web page's contents based at least in part on the query terms. In the latter case, the abstract may include “snippets” of the corresponding web page that contain instances of the query terms and the text surrounding those instances.

Significantly, one or more search result listing(s) on the search results web page are also constructed in such a manner that those search results listings also include, either as part of the abstract or in addition to the abstract, the detailed information items that the web crawler extracted from the web pages corresponding to those search result listing(s) using the content provider's structure-indicating information, as described above with reference to block 208. In one embodiment of the invention, each such extracted information item is labeled, within the search result listing that corresponds to the web page from which that information item was extracted, with the category (e.g., name, address, phone number, product name, price, review, etc.) to which that extracted information belongs. As a result, detailed information items extracted from one or more of the relevant web pages are “surfaced” or “highlighted” on the search results web page.

In block 216, the search engine returns the generated search results web page to the user as a response to the user's previous submission of the query terms. In one embodiment of the invention, the search engine returns the search results page to the user's computing device over the Internet. Typically, the user's web browsing application receives the search results page and displays the search results page to the user. Because the search results page conveniently “surfaces” or “highlights” detailed information items that the web crawler was able to extract from the content provider's web page(s), the search engine user does not need to cause his web browsing application to request the full versions of those web pages over the Internet. The search engine user is much less likely to need to search, manually, through such a full version of such a web page in order to find a specific information item in which he was interested (the user might have only been interested in one specific information item and no other information on that web page). Such information items are likely to be present on the search results page within the search results listings themselves. As is discussed above, but for the content provider's provision of the structure-indicating information, the search engine provider's web crawler might not have been able to locate and extract those information items from the content provider's web pages. Without the structure-indicating information, the web crawler might not have even had any information that indicated which categories of information were actually present in the content provider's web pages.

The relative ease with which the user is enabled to locate specific detailed information items within the search results web page itself is likely to make the user want to use the current search engine again and again. The user is likely to want to recommend the current search engine, over other search engines, to his friends and acquaintances. As a result, the search engine provider's user base increases. The traffic to the search engine provider's “front page” increases. This allows the search engine provider to increase advertising revenues from prospective advertisers, as advertisers seek to have their advertisements placed on the search engine provider's “front page,” or on the search results pages that the search engine generates, due to the large quantity of users who visit and view that “front page” and/or receive those search results pages. Although a single content provider is discussed above for sake of simplicity of illustration, in some embodiments of the invention, the search engine provider will enter into multiple agreements with multiple different content providers; under such circumstances, the categories of information items that the web crawler extracts from the web pages of each different content provider's web site(s) may differ.

In block 218, the search engine provider provides compensation to the content provider in accordance with the agreement into which both previously entered. In one embodiment of the invention, the compensation is monetary compensation, and is provided to the content provider in an automated manner. For example, the agreement might indicate that each time that an information item extracted from any of the content provider's web pages—using the content provider's structure-indicating information—is presented to a user on a search results web page, the search engine provider will pay the content provider some specified monetary amount. For another example, the agreement might indicate that each time that a user “clicks on” or otherwise selects or activates a hyperlink or other reference to any of the content provider's web pages whose corresponding search result listings on the search results web page contain at least one information item that was extracted using the content provider's structure-indicating information, the search engine provider will pay the content provider some specified monetary amount. Alternatively, the agreement might indicate that the search engine provider will pay a specified amount as a single lump sum or periodically regardless of whether the content provider's content is ever displayed in a search results page and/or regardless of whether a user ever “clicks on” a hyperlink to the content provider's content from a search results page. An automated process executing on the search engine provider's computing device may maintain a tally of the amount that the search engine provider currently owes to the content provider. The automated process may periodically, or in response to some specified increase in that tally, credit a specified bank or other financial account with monetary amounts owed to the content provider.

### Example Information Item-Surfacing Search Results Web Page

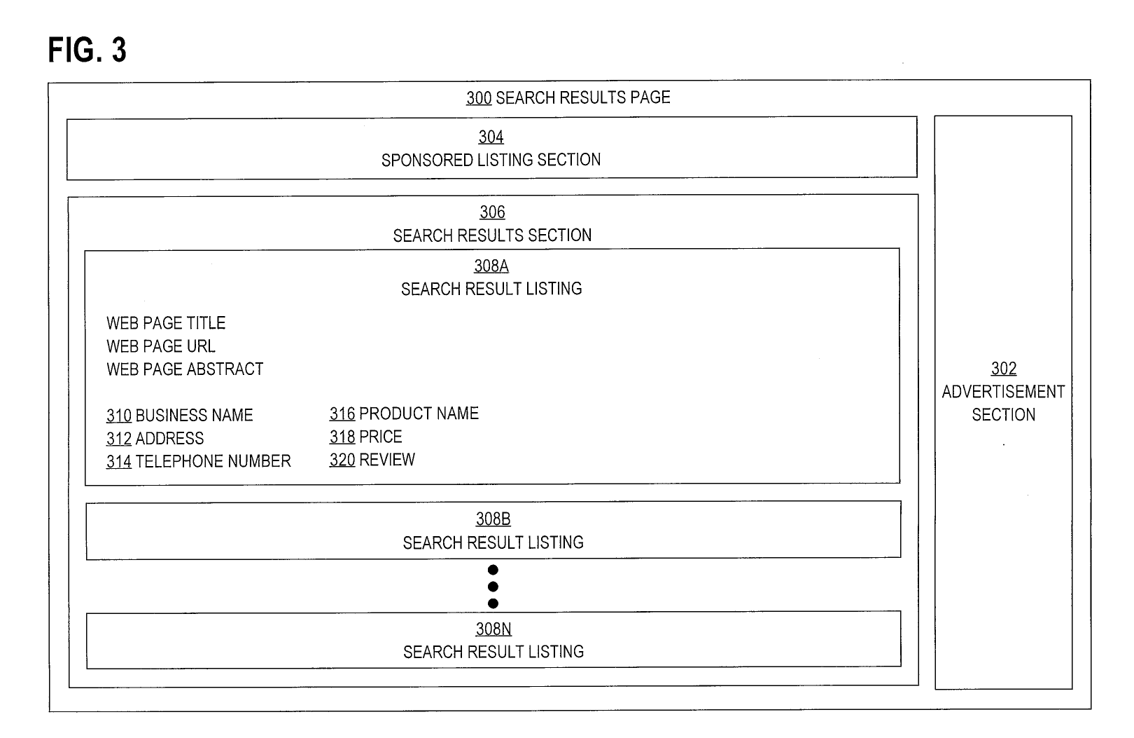

FIG. 3 is a block diagram that illustrates an example of a search results web page that contains a search result listing that includes detailed information items that were automatically extracted from the web page corresponding to the search results listing using structure-indicating information that the content provider (who hosts the web page) provided to the search engine provider, according to an embodiment of the invention. As shown in FIG. 3, search results web page 300 includes an advertisement section 302, a sponsored listing section 304, and a search results section 306. In alternative embodiments of the invention, such a search results web page may contain more, fewer, or different sections than those illustrated in this example.

Search results section 306 includes search result listings 308A-N. Each of these search result listings pertains to a separate web page that the search engine determined to be relevant to query terms that the user (the viewer of search results web page 300) previously submitted to the search engine. Each of search result listings 308A-N includes a title of the corresponding web page, a URL-indicating hyperlink of the corresponding web page, and an abstract for the corresponding web page. One or more (though perhaps fewer than all) of search result listings 308A-N additionally include one or more information items that the search engine provider's web crawl automatically extracted from the corresponding web pages using, as a guide, structure-indicating information that the content provider of that web page previously provided to the search engine provider in accordance with the agreement into which both the search engine provider and the content provider previously entered. For example, search result listing 308A includes a business name information item 310, an address information item 312, a telephone number information item 314, a product name information item 316, a price information item 318, and a review information item 320. Each such information item 310-320 is labeled with the category to which that information belongs, and specifies the value that the web crawler extracted from the web page using the content provider's structure-indicating information. Information items 310-320 have been “surfaced” on search results web page 300 so that the viewer of search results web page 300 does not need to cause his web browsing application to request the corresponding web page and so that the viewer does not need to hunt through that web page manually to locate any of the “surfaced” information items 310-320.

### Computing Dynamic Amount to Compensate Content Provider

In one embodiment of the invention, the amount that the search engine provider agrees to pay to the content provider in exchange for the content provider's information, as discussed above, is dynamically based on the value that the search engine provider's use of the information will have to the search engine provider. For example, the search engine provider may agree to compensate the content provider in an amount that is based on the output of a specified algorithm that takes certain specified inputs. Thus, in one embodiment of the invention, a computing device automatically determines an estimated revenue value that estimates the amount of revenue that an enhanced version of the search results page, enhanced based on the information obtained from the content provider, will probably result from the search results page. The computing device that determines the estimated revenue value may be owned and operated by the search engine provider, for example. In one embodiment of the invention, the search engine provider agrees to pay the content provider some specified fraction of the estimated revenue value. In one embodiment of the invention, the estimated revenue value is computed to be equal to (a) the estimated revenue value of the search results page when the content provider's information is used to enhance the search results page, minus (b) the estimated revenue value of the search results page when the content provider's information is not used to enhance the search results page.

There are several different factors which the algorithm can take into account when determining the estimated revenue value of the search results page. In one embodiment of the invention, the computing device determines the estimated revenue value based at least in part on the uniqueness of concepts that are covered by search results in the search results page. If a particular search result on a search results page contains a concept that no other search result (or less than a specified quantity or percentage of search results) produced by the same query contains, then this is an indication that the particular search result covers a unique concept. In such an embodiment of the invention, each such unique-concept-covering search result that is placed on the search results page specifically as a result of the information obtained by agreement from the content provider increases the estimated revenue value of the search results page. A search results page that contains many such unique-concept-covering search results (which results would not have been on the search results page but for the information obtained by agreement from the content provider) will be computed to have a greater estimated revenue value than a search results page that contains few or no such unique-concept-covering search results.

Often, a search engine provider receives monetary amounts from advertisers when users of the search engine click on certain elements that have been displayed on the search results page. For example, such elements may include sponsored search results that the advertiser has asked the search engine provider to place on the page, and/or non-search-result advertisements (often graphical in nature) that the advertiser has asked the search engine provider to place on the page along with the search results (especially when either the search results or the query terms contain key words that are relevant to the advertiser's advertised product or service). The enhancement of the search results page using the information obtained by agreement from the content provider may cause more users to click on such elements, thereby causing the search results page to generate more revenue than the search results page would have generated without the enhancement. Therefore, in one embodiment of the invention, a computing device automatically tracks the amount of revenue that each search results page produces. For each set of query terms entered by searching users, and over a specified period of time, the computing device measures (a) the average amount of revenue that is generated by a version of the search results page that is produced based on those query terms and that has not been enhanced using the information obtained by agreement from the content provider and (b) the average amount of revenue that is generated by a version of the search results page that is produced based on those same query terms and that has been enhanced using the information obtained by agreement from the content provider. The difference between the two is an indication of the content provider's information's contribution to the estimated revenue value of the search results page. In one embodiment of the invention, this difference is used as at least one factor in the determination of the estimated revenue value of each search results page.

In one embodiment of the invention, a content provider's information, provided by agreement with the search engine provider, is actually inserted into one or more search result listings on the search results page (for example, within abstracts). In one embodiment of the invention, the contribution of the content provider's information to the estimated revenue value of the search results page is based at least in part on whether the content provider's information actually appears within the top N results (where N is some specified number) on the search results page, and how high that information appears within the results on that page. In one embodiment of the invention, the relevance of (a) the search result listings in which the content provider's information appears on a search results page to (b) the query terms that were submitted to produce the search results page influences the determination of the contribution of the content provider's information to the search result page's estimated revenue value. In one embodiment of the invention, the position of the search result listing(s) containing the content provider's information, among the other search result listings on the search results page, is used as a basis for determining how much the search engine provider will pay the content provider due to that search results page having been enhanced based on the content provider's information provided by agreement. For example, if the very first-listed, most relevant search result listing on the search results page contains the content provider's information provided by agreement, then the search engine provider may pay the content provider a larger amount of money than if the content provider's information only appears in a less relevant search result listing shown on the bottom of the relevance-ranked search results page. The search engine provider may pay the content provider on a page-by-page basis, such that the search engine provider may pay the content provider larger amounts of money for some pages (e.g., pages on which the content provider's information occurs within highly relevant search result listings) than for other pages (e.g., pages on which the content provider's information occurs within less relevant search result listings or not at all).

In one embodiment of the invention, the estimated revenue value of a search results page is determined based at least in part on the quantity or frequency of “click-throughs” to content that is produced, owned, or managed by the content provider that provided the information to the search engine provider by agreement. A large number of users clicking on search results that cause their browsers to fetch the content provider's pages may be indicative that the content provider's content is valuable. Similarly, if the ratio of (a) the number of users who click on a particular search result that points to the content provider's content after seeing that particular search result on the search results page to (b) the number of users who do not click on the particular search result after seeing that particular search result on the search results page, then this may be indicative that the content provider's content is valuable. Therefore, in one embodiment of the invention, the contribution of the content provider's information to the estimated revenue value of a search results page is determined based at least in part on the number or frequency of users who clicked on links (within the search results page) that point to the content provider's content (e.g., web pages on the content provider's web site). With this and other factors described above, the amount that the search engine provider agrees to pay to the content provider may be based on the estimated contribution of the content provider's information to the estimated revenue value of a search results page.

In one embodiment of the invention, an estimated revenue value for a search results page is determined automatically by a computing device every time that such a search results page is generated in response to a user's query. The amounts owed to each content provider whose information was used to enhance the search results page may be determined after the generation of each such page, and/or after a user has interacted with the page and navigated away from the page using his browser.

### Hardware Overview

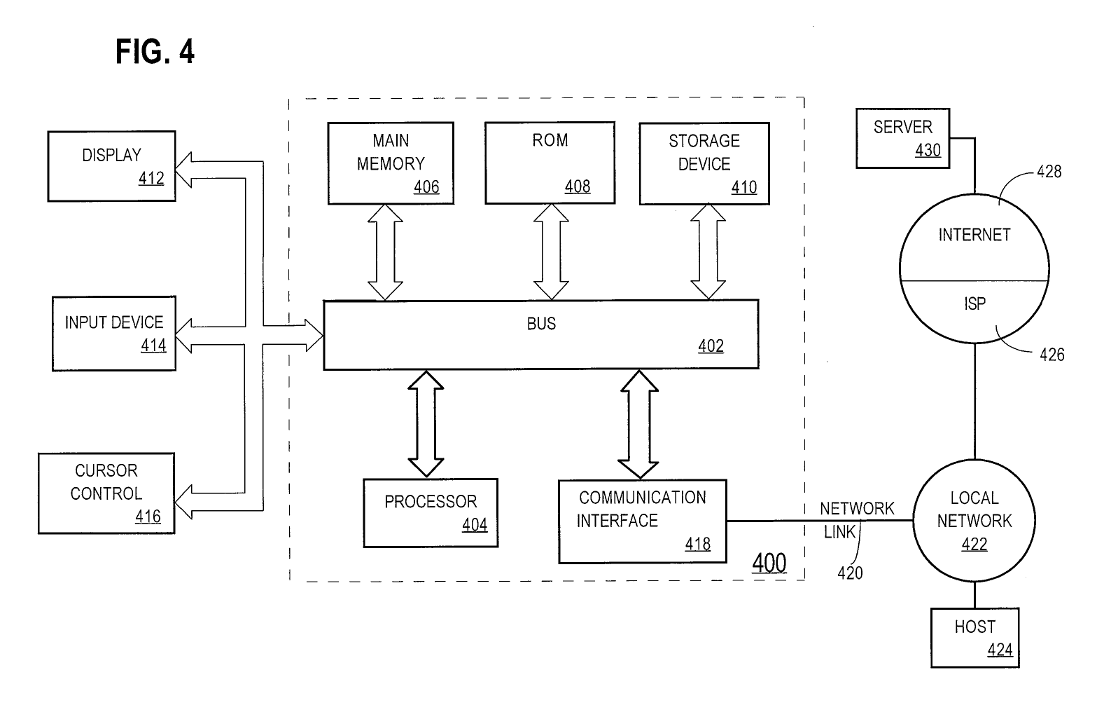

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

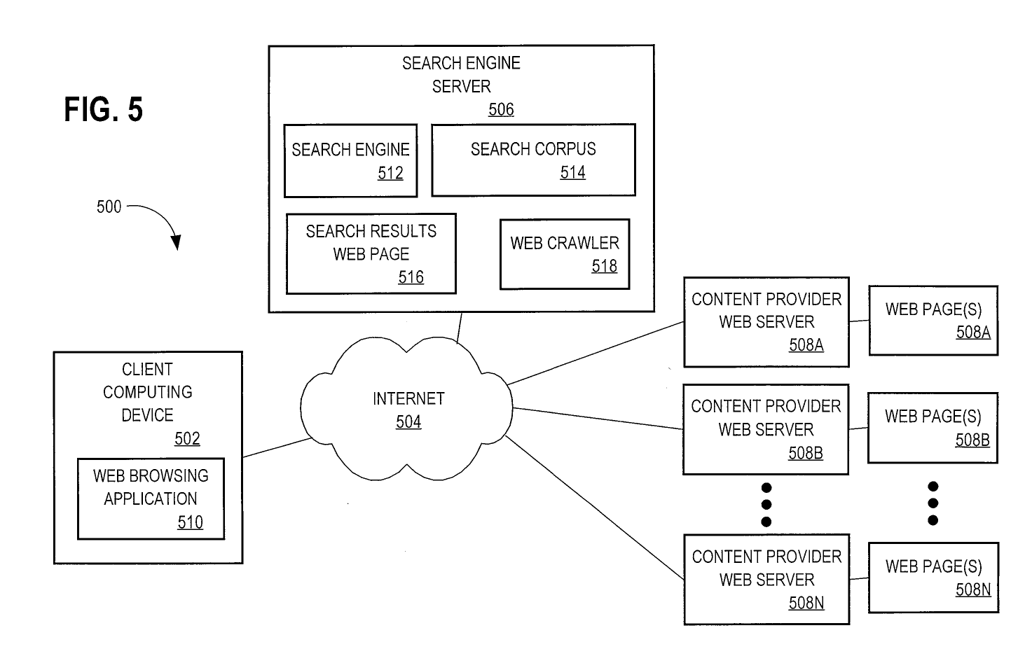

FIG. 5 is a block diagram of an example multi-computing device, Internet-based system in which embodiments of the invention may be used. Example system 500 includes a client computing device 502, which is connected communicatively to Internet 504, to which is communicatively coupled to search engine server 506 and to each of content provider web servers 508A-N. A web browsing application 510 executes on client computing device 502. Web browsing application 510 sends user-specified query terms over Internet 504 to search engine server 506. A search engine 512 executing on search engine server 506 receives the query terms over Internet 504. Search engine 512 responsively searches a web corpus 514 (stored on search engine server 506) to determine a set of web pages that are relevant to the query terms. Search engine 512 generates a search results web page 516 that contains search result listings that refer to “privileged user” web pages and/or that contain detailed extracted information items of the kind discussed above. Search engine 512 sends search results web page 516 over Internet 504 to client computing device 502 in response to the submission of the query terms. Web browsing application 510 renders search results web page 516 and displays search results web page 516 to a user of client computing device 502.

A web crawler 518 also executes on search engine server 506. Web crawler 518 periodically, continuously, and automatically follows hyperlinks within content provider web pages 520A-N that are stored on various ones of content provider web servers 508A-N, thereby crawling those web pages. Web crawler 518 may supply, to one or more of content provider web servers 508A-N, authentication credentials that were given to the search engine provider in accordance with an agreement entered into between the search engine provider and the content provider who controls web pages that are hosted on the content provider web server. In this manner, web crawler 518 is enabled to crawl “privileged user” web pages that are stored on some of content provider web servers 508A-N. Web crawler 518 stores a copy of each such crawled web page in web corpus 514, and generates, in web corpus 514, an index entry that associates that web page's words with that web page's unique identifier (e.g., URL). Additionally, if the web page is associated with structure-indicating information that the search engine provider obtained from the web page's content provider pursuant to the agreement, then web crawler 518 extracts and categorizes information items from that web page using the structure-indicating information as a pattern or guide. Web crawler 518 stores, in web corpus 514, associations between (a) the extracted information items, (b) the categories to which those information items belong, and (c) the unique identifiers of the web pages from which the information items were extracted. In one embodiment of the invention, web crawler 518 and search engine 512 are owner and operated by a different party than any party that owns or operates any of content provider web servers 508A-N or any of the web pages hosted or stored thereon.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising steps of:
determining an extent to which use of a content provider's information to enhance a search results page, produced by a search engine owned by a search engine provider, caused an estimated revenue value of the search results page to increase; and
paying the content provider an amount that is based at least in part on said extent;
wherein the content provider's information was made available to the search engine provider due at least in part to an entrance of the content provider and the search engine provider into an agreement whereby the search engine provider agreed to compensate the content provider in exchange for the content provider making the content provider's information available to the search engine provider;
wherein the steps are performed by one or more computing devices.

2. The method of claim 1, wherein determining the extent comprises determining the extent based on a number of search results that contain concepts that are represented in search results that have been enhanced by the availability of the content provider's information and that are not represented in any other search results.

3. The method of claim 1, wherein determining the extent comprises determining the extent based on a number of search results on the search results page that contain content that the content provider made available to the search results provider pursuant to the agreement.

4. The method of claim 1, wherein determining the extent comprises determining the extent based on both (a) an amount of revenue that the search engine provider realized as a consequence of displaying a version of the search results page that had not been enhanced using the content provider's information and (b) an amount of revenue that the search engine provider realized as a consequence of displaying a version of the search results page that had been enhanced using the content provider's information.

5. The method of claim 1, wherein determining the extent comprises determining the extent based on a position, within multiple search results listings on the search results page, of a search result listing that contains at least a portion of the content provider's information that the content provider made available to the search engine provider pursuant to the agreement.

6. The method of claim 1, wherein determining the extent comprises determining the extent based on a quantity of users that click on links that are contained within the search results page and that refer to content that is provided by the content provider.

7. The method of claim 1, wherein the content provider's information is at least one of:
(a) structural information that indicates at least a part of a structure of one or more web pages on a web site of the content provider, and (b) content on the web site for which a user is required to pay or subscribe in order to obtain access.

8. The method of claim 1, wherein the content provider's information is neither: (a) structural information that indicates at least a part of a structure of one or more web pages on a web site of the content provider, nor (b) content on the web site for which a user is required to pay or subscribe in order to obtain access.

9. A volatile or non-volatile computer-readable medium that stores instructions which, when executed by one or more processors, cause the one or more processors to perform steps comprising:
determining an extent to which use of a content provider's information to enhance a search results page, produced by a search engine owned by a search engine provider, caused an estimated revenue value of the search results page to increase; and
paying the content provider an amount that is based at least in part on said extent;
wherein the content provider's information was made available to the search engine provider due at least in part to an entrance of the content provider and the search engine provider into an agreement whereby the search engine provider agreed to compensate the content provider in exchange for the content provider making the content provider's information available to the search engine provider.

10. The computer-readable medium of claim 9, wherein determining the extent comprises determining the extent based on a number of search results that contain concepts that are represented in search results that have been enhanced by the availability of the content provider's information and that are not represented in any other search results.

11. The computer-readable medium of claim 9, wherein determining the extent comprises determining the extent based on a number of search results on the search results page that contain content that the content provider made available to the search results provider pursuant to the agreement.

12. The computer-readable medium of claim 9, wherein determining the extent comprises determining the extent based on both (a) an amount of revenue that the search engine provider realized as a consequence of displaying a version of the search results page that had not been enhanced using the content provider's information and (b) an amount of revenue that the search engine provider realized as a consequence of displaying a version of the search results page that had been enhanced using the content provider's information.

13. The computer-readable medium of claim 9, wherein determining the extent comprises determining the extent based on a position, within multiple search results listings on the search results page, of a search result listing that contains at least a portion of the content provider's information that the content provider made available to the search engine provider pursuant to the agreement.

14. The computer-readable medium of claim 9, wherein determining the extent comprises determining the extent based on a quantity of users that click on links that are contained within the search results page and that refer to content that is provided by the content provider.

15. The computer-readable medium of claim 9, wherein the content provider's information is at least one of: (a) structural information that indicates at least a part of a structure of one or more web pages on a web site of the content provider, and (b) content on the web site for which a user is required to pay or subscribe in order to obtain access.

16. The computer-readable medium of claim 9, wherein the content provider's information is neither: (a) structural information that indicates at least a part of a structure of one or more web pages on a web site of the content provider, nor (b) content on the web site for which a user is required to pay or subscribe in order to obtain access.

17. An apparatus comprising:
one or more processors;
a web crawler that (a) automatically accesses pages that are stored on a content provider's web server after providing, to the content provider's web server, credentials that the content provider made available to a search engine provider according to an agreement with a search engine provider, (b) stores copies of said pages within a web search corpus of the search engine provider, and (c) extracts information items from said pages based on structure-indicating information that the content provider made available to the search engine provider according to said agreement; and
a search engine that (a) receives query terms from a user, (b) generates, based on said query terms, a search results web pages that contains one or more search result listings that include at least one particular search result listing that contains information extracted from at least one particular page of said pages, and (c) returns said search results web page to said user.

18. The apparatus of claim 17, wherein the web crawler extracts information from said pages based on a regular expression that the content provider made available to the search engine provider in exchange for compensation specified in the agreement.

19. The apparatus of claim 17, wherein the web crawler extracts information from said pages based on a schema that the content provider made available to the search engine provider, wherein the schema specifies where one or more information items belonging to specified categories are located on said pages.

20. The apparatus of claim 17, wherein said user has not established any account with the content provider, and wherein the search engine provider provides monetary compensation to the content provider in accordance with the agreement.

21. The apparatus of claim 17, wherein the structure-indicating information indicates where a particular category of information item can be found on said pages, wherein the search engine generates the search results web page at least in part by generating a search results web page that indicates both the particular category and a value corresponding to that particular category, and wherein the particular category is at least one of (a) a name, (b) an address, (c) a telephone number, (d) a product identity, (e) a price, or (f) a review.
